(19) United States
(12) Patent Application Publication
(10) Pub. No.: US 2004/0151292 A1
(43) Pub. Date: Aug. 5, 2004

(54) Prepaid and postpaid subscriber telephony platform

(76) Inventor: David J. Larsen, Morgan Hill, CA (US)

Correspondence Address: DALLAS OFFICE OF FULBRIGHT & JAWORSKI L.L.P., 2200 ROSS AVENUE, SUITE 2800, DALLAS, TX, 75201-2784, US

(21) Appl. No.: 10/356,406

(22) Filed: Jan. 31, 2003

(51) Int. Cl. H04M 15/00

(52) U.S. Cl. 379/114.2; 379/114.01

(57) ABSTRACT

A platform is disposed between a subscriber and a telephony switch such as a Class 5 switch. The platform receives indications of calls placed to and by a subscriber and identifies a service type of each of the calls. The platform validates the subscriber as an active customer based on automatic number identification. The platform determines if the subscriber is eligible to receive or place a call, and/or employ calling features, by looking-up in a local platform database an account status of the customer. For a prepaid customer this includes establishing whether the subscriber has sufficient funds in a prepaid account to pay tolls related to a call. The platform routes an eligible call to or from the subscriber through the switch and a telephony signal system, creates a call detail record and updates subscriber information in the database upon completion of the call.

### TECHNICAL FIELD

The present invention is broadly related to communications services and equipment, and specifically related to a prepaid and postpaid telephony services platform.

### BACKGROUND OF THE INVENTION

Problematically, in the prepaid telephone service industry a prepaid customer cannot be treated the same as a traditional credit based telephony customer. A prepaid telephone call cannot be tracked and tallied by existing systems for billing at a later time. Due to the nature of prepaid telephone service, the service must be paid for in advance. Resultantly, if any services are not prepaid, the services should be blocked or otherwise denied for that customer. In conventional credit based telephone service, local toll calls, long distance calls, and the like, can be tracked in real time, but billed at a later time through a billing service. In prepaid service, because of limitations existing in telephone systems, if a prepaid subscriber were to be allowed to place toll calls or long distance calls, credit would be extended to a customer who does not have credit. Therefore, such services are typically blocked for prepaid customers. Traditionally, prepaid subscribers have been forced to accept being blocked from using such services, or they have used what is commonly termed a prepaid calling card, where a card or account is debited in real time on the occasion of a toll call and for that one call or service. Platforms used to gain prepaid access through a calling card typically use an account number and/or a Personal Identification Number (PIN), and/or require dialing a toll free access number in order to acquire a platform. In existing prepaid systems, if a prepaid customer is not qualified for an amount the customer must be blocked or cut off from accessing a service. For this blocking service a prepaid telephone company must pay an extra substantial charge to a hosting Incumbent Local Exchange Carrier (ILEC) or Competitive Local Exchange Carrier (CLEC).

For a credit based customer, when a toll call is placed, the customer picks up their telephone to dial the number and a traditional telephone company, such as an ILEC or CLEC, identifies the originating number as an active account and allows the call. This call will typically make use of background signaling, known as Signaling System 7 (SS7), which looks ahead to see if the number called is in service, busy, or available. At the same time, the telephone company's switch checks a Line Information Database (LIDB) and/or Switch Control Point (SCP) to see if any calling features that the customer has attempted to use, for example call waiting or three-way calling, are available to that customer. This system is too rigid for use with prepaid customers because the LIDB and SCP databases of customer available services are typically fixed databases, which cannot be adjusted in real time or even in a relatively short period of time. This is to say, prior art LIDB and SCP databases are not dynamic. Such databases are typically updated over a number of days. A change in service typically requires a customer call to the telephone company to order a service change. A matter of days later, access to that service is enabled. Additionally, a prepaid customer typically does not have access to calling features such as call block, call return, and the like, because these services are charged to a credit based customer on a per use basis and, as discussed above, ILECs and CLECs do not extend credit to prepaid telephone customers.

So within the prepaid telephony industry problems arise concerning how to allow a prepaid customer to make toll calls, or local calls in a Metered and Measured (M & M) market. Further or additional problems arise when a prepaid customer wishes to deviate from preset features, for example if the customer wishes to use active calling features such as call block. The prior art fails to address these problems, while collecting for telephone services in advance from the prepaid customer. One attempted solution employed by various ILECs to address these problem are “Flat-Rate” plans, which are a form of pre-payment. However, such plans typically require a significant financial commitment and do not carry prepayments forward. Thus, such plans are often too expensive, or overly wasteful for a credit impaired customer.

### BRIEF SUMMARY OF THE INVENTION

The present invention is directed to systems and methods which allow a prepaid customer to make toll calls and allows a prepaid customer to deviate from preset features if they want to use active calling features through the use of a telephony platform disposed between customer premises equipment and an ILEC or CLEC Class 5 switch, or the like.

Around five million prepaid phone service customers, or potential prepaid subscribers, are available in the United States, of which relatively few are being fully served or can be served, because of the nature of existing credit based telephone service provision systems. These customers may be capable of paying for service but they are credit impaired due to circumstances. For example, these customers may not have a requisite credit rating or a Social Security Number. Individuals without telephone service, do not have the ability to use “911” emergency services or the ability to place toll free calls. By being able to subscribe to a prepaid system, customers at least have a basic level of telephone service and access to vital governmental services through “911” and toll free calls. If a customer is provided telephone service, it is desirable to provide telephone services similar to a credit based system, and to the extent that credit based customers have. In serving a prepaid telephone customer, a telephone service provider employing the present platform is able to allow prepaid customers to have access to most or all telephone services available to credit based customers. Meanwhile, the service provider is able to collect for the services in advance and debit individual accounts in real time, in effect affording the service provider the advantages of a pre-paid calling card and avoiding the attached high cost of the card use for the customer, without requiring the customer to dial multiple numbers.

An advantage of the present inventive systems and methods over prior art systems and/or methods is that a prepaid customer does not have to change how he or she traditionally does telephone business by dialing a series of additional numbers just to make a call. The present systems and methods only change how the customer pays for the services. In other words, the present systems and methods emulate a credit based telephony environment for a prepaid telephony customer. Unlike calling card platforms that require dialing an access number, entry of an account number and entry of a PIN, the present platform employs a more reasonable manner of access and cost effective approach that customers can better afford. The present platform is disposed between the customer and a Class 5 switch or its equivalent. Since the prepaid customer needs to be fully pre-approved for a call before the call progresses further, in order to provide the same quality of service as is provided to the credit based customer, this pre-approval process needs to be carried out very quickly and seamlessly. The present platform approves the customer's call in real time, before the dialed digits are presented to a Class 5 switch, and before the call attempt utilizes SS7 to start reserving voice trunks for call completion. Although any required service authorizations, such as calling feature authorizations, might take place within or after the Class 5 switch, after the dialed digits are presented to the Class 5 switch, this is not necessary when employing the present invention. Placement of the present platform before the Class 5 switch facilitates emulation of conventional credit based telephone service provisioning for both prepaid and post-paid customers of a service provider. Since the present platform is placed in front of a Class 5 switch, a prepaid customer who has paid for service for that month, or other time period, can be verified by the platform checking to make sure that the customer has an active account and/or account balance sufficient to cover cost for the call made, in advance of the call being completed.

As a further advantage the present platform may be used for providing services to postpaid (credit based) telephony customers as well as prepaid telephony customers. Therefore, a telephony service provider employing the present platform can provide telephony services to both prepaid and postpaid telephony customers using the same platform and associated back-office databases.

Data flows between the present platform and back-office databases including data related to the identity of the subscriber or customer, subscriber account configuration data, circuit data, Call Detail Record (CDR) data, call rating data, call routing data, taxation data, transaction data, and/or the like. This data flow facilitates subscriber account management including providing information related to provision of service or features, suspension of services or features, restoration of service or features and disconnected accounts. This data flow can carry out account credits, account debits, or rearrangement of funds in a customer account, as well as managing funds distribution. The data provided from the back-office to the platform facilitates subscriber authentication and validation by identifying the customer type as pre-paid or postpaid and validating the subscriber by providing information for determining if the subscriber is disconnected, suspended or a valid subscriber.

In providing communications services, the calling number Automatic Number Identification (ANI) is immediately recognized and validated by the platform. If the call is then identified as a local call, the call is completed, a Call Detail Record (CDR), in a standard format, is created and the subscriber information database is updated to show a record of the call.

For an outgoing toll or M & M call request the platform pre-rates the call for pre-paid customers. The platform then routes the toll call and disconnects the validation call used to authorize and pre-rate a pre-paid customer. The platform them creates and stores a CDR, and then updates subscriber information.

The present platform processes inbound service requests by identifying the service type, such as regular incoming call, collect call, conference call or the like. The platform then provides service authorization or denies service. The platform authorizes and prerates collect calls based on provisioning and business rules. Further, authorizing and prerating includes determining the availability of call waiting, call forwarding, voice mail, distinctive ring, Caller ID, call blocking, time of day re-direct, and/or other calling features. The platform also detects a busy status or a no answer status. When an answered call is terminated, the platform creates a CDR and updates subscriber information.

For a “911” call or an outgoing toll-free (“800”) call request the call is routed and a CDR created for authorized customers. For operator or directory assistance requests and call feature requests such as *67 or *69 the platform validates and pre-rates the request for a pre-paid customer, routes the call, disconnects the validation call used to authorize and pre-rate the call for a pre-paid customer, creates a CDR, and updates subscriber information. The present platform also provides for Operator Interrupt Requests.

For a charge-back or “900” call by pre-paid customers the present platform may require that a PIN be entered as a measure of fraud prevention. An optional PIN requirement may be employed by postpaid subscribers, at their choosing, for their own security reasons. Following entry of any required PIN the “900” call is processed by the present platform similar to a long distance call.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 is a diagrammatic illustration of a telephony system employing the present prepaid and postpaid subscriber telephony platform;

FIG. 1A is a diagrammatic illustration of an embodiment of the present platform;

FIG. 2 is a diagrammatic illustration of call and service provisioning employing the present platform;

FIGS. 3A and 3B together comprise a diagrammatic illustration of provision of service and features related to outgoing phone calls in accordance with the present invention;

FIG. 4 is a diagrammatic illustration of provision of service and features related to incoming phone calls in accordance with the present invention; and

FIG. 5 is a diagrammatic illustration of establishment and provisioning of prepaid or postpaid service in accordance with the present invention.

### DETAILED DESCRIPTION OF THE INVENTION

Unlike other platforms that permit pre-paid access, such as pre-paid calling cards, the present platform resides between the caller and any Class 5 switch or other equivalent telephony switch, whether that Class 5 switch is a Regional Bell Operating Company (RBOC) switch or a third party Class 5 switch. In addition, under the present platform, the caller need not call an access number to use the platform nor enter a PIN. The caller need only be a valid subscriber to the present telephone service, whether pre-paid or postpaid. The caller's identification is provided by the ANI for the phone line from which the call is being made.

The present systems and methods enable management of an account whether it is a credit account or a prepaid account. If the account is a prepaid account, a method of managing the funds that are distributed within that account is employed by the present systems and methods. To this end the present systems and methods provide validation for customer calls. Whereas prior art prepaid calling systems use special access numbers, (PINs), and/or a variety of different codes or numbers for verification, the present systems and methods provide verification in a manner that outwardly appears to be the same as that provided a conventional credit based customer. The present systems and methods employ the ANI of a calling number, or called number for incoming calls, as an authenticating number.

As in any telephone service, whether it is credit based or prepaid, a database should be created that identifies a customer/subscriber, assigns a telephone number to that customer, and has an ability to print out call detail records so that the customer can be billed. However, in the case of a prepaid telephony customer, the customer should be notified of debits to his account and any need for additional prepayment. Such “back office” databases preferably have some form of data that indicates whether a customer is allowed to make toll calls or international calls. Other databases typically apply taxes to the costs involved in calls, and some data records of the types of transactions that are available is typically maintained. All those databases together require management of the data, referred to herein as call account management. In order to manage accounts call provisioning by the present platform preferably employs locally available portions of these databases to tell the systems in the telephone networks what kind of call can be used, what kinds of features can be used and whether a service is suspended disconnected or restored for a customer.

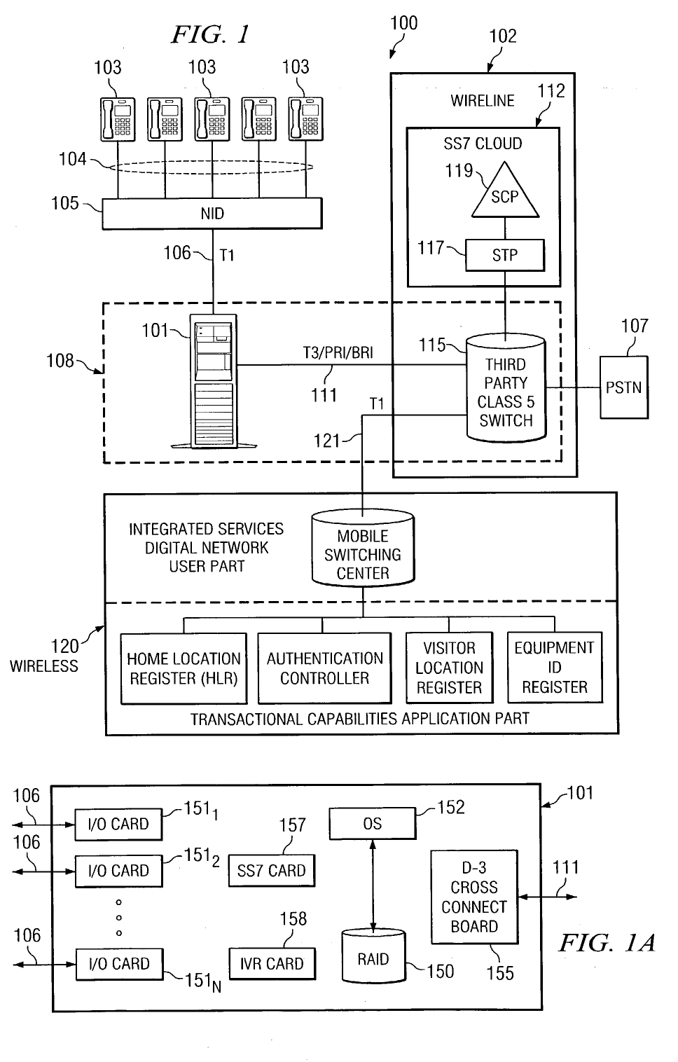

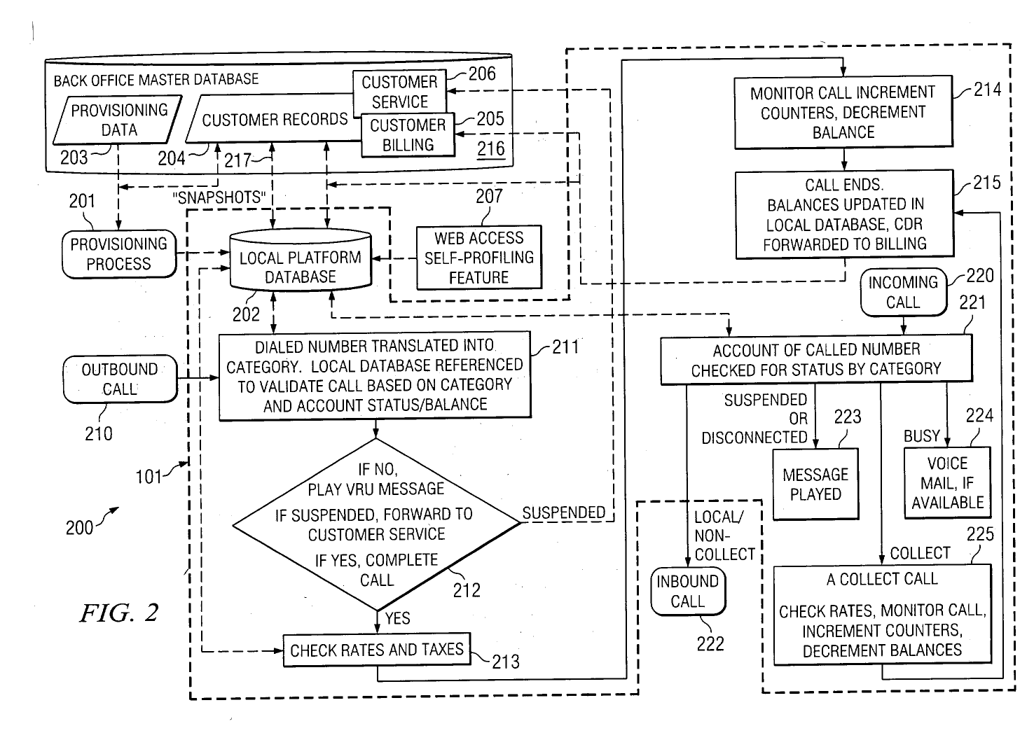

Turning to FIG. 1, communication system embodiment 100 is adapted for use of the present prepaid and postpaid subscriber telephony platform by placement of present platform 101 between customer premises equipment, such as telephone instrument(s) 103, and a Class 5 switch 115, or the like, in wireline system 102. Unlike other existing platforms, all call provisioning transactions take place in platform 101 before the calling digits are passed to the Class 5 switch for call completion. In all other prepaid platforms, the caller must access a platform through a Class 5 switch and then be validated. In accordance with the present invention, subscriber's telephone 103 or other equipment is connected to network 100 via local loop, copper twisted pair 104, or the like, which in turn is connected to network interface device (NID) 105. NID 105 typically employs cross-connects and multiplexing channeling equipment to connect with one or more trunk level one links (T1s) 106. These T1s are intercepted prior to Class 5 switch 115 by present platform 101. Present platform 101 preferably passes communications on to Class 5 switch 115 via a T1 or trunk line three (T3) line, a Primary Rate ISDN (PRI), Business Rate ISDN (BRI), or the like (111). Class 5 switch 115 is typically owned and operated by a third party CLEC, a CLEC that owns platform 101, or an ILEC Regional Bell Operating Company (RBOC). Class 5 switch 115 connects inbound calls from, or outbound calls to, the Public Switched Telecommunications Network (PSTN) 107. Platform 101 and Class 5 switch 115 may be collocated at 108, possibly in a “COLLO (Collocation) Hotel”, a third party CLEC's location, an ILEC's location, or at the platform owner's location. Switch transfer point (STP) 117 and Switch control point (SCP) 119 are typically part of Signal System 7 (SS7) 112, and are usually owned and operated by third party carriers as a part of a network within and outside of the conventional telephone system. This SS7 network or cloud 112 sets up calls to find out if a party is busy or whether the call can be completed before reserving voice trunks. Turning to box 120, an embodiment of wireless communication network system 120 is illustrated. To call a wireless customer a call is directed out of Class 5 switch 115 through, for example T1 link 121 into wireless system 120.

Typically, arrangements may be made to use a cage or rack space to collocate platform 101 with an ILEC Class 5 switch at a premium. Typically, a CLEC can provide more economical arrangements for rack space at a COLLO hotel, which is set up with multiple T1 and T3 links, in and out.

Turning to FIG. 1A, platform 101 preferably takes the form of a server class computer with mass storage capability 150 such as a Redundant Array of Inexpensive Disks (RAID) and input/output (I/O) functionality 151₁-151_{N}, such as one or more INTEL DIALOGIC® cards to connect T1s (106) to the platform. The platform employs operating system 152 such as LINUX, UNIX or WINDOWS NT and multitasks to look up information from local databases maintained in mass storage 150. The dialogic cards may each be a quad T1, receiving up to four T1 lines. Within any T1 there are typically up to twenty-four voice circuits. So each voice line is identified within the platform, every twisted pair is identified by a numeric designation, and internal mapping is employed to identify, to the platform operating system, the line associated with a number or a phone number associated with a line. So the platform does not ring a telephone number, it rings a circuit number in accordance with the internal mapping. The T3 or PRI line (111) coming out of the platform may be a DS3 link, or the like, and typically comprises twenty-eight T Is, for example. The T3 or PRI preferably interfaces with the present platform via a DS3 cross-connect board 155, or the like. This DS3 board gathers twenty-eight T1s, cross-connects them and outputs them into a DS3 by multiplexing. Other functionality in the present platform may be provided by voice cards 157 and one or more SS7 cards 158.

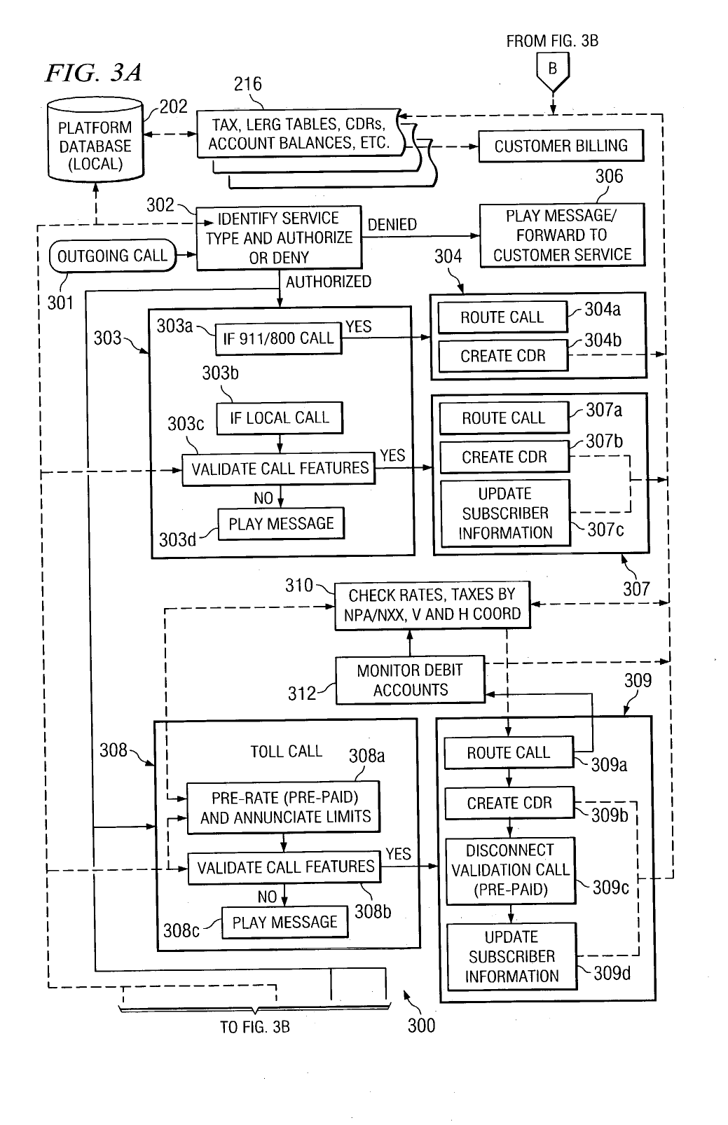

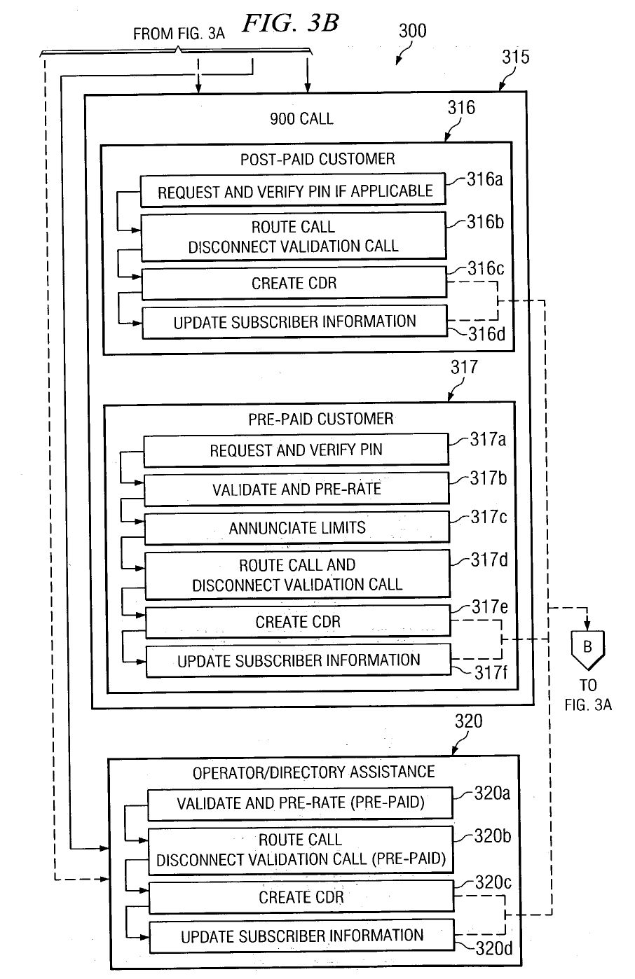

Turning to FIG. 2, operation 200 of platform 101 of FIG. 1 is illustrated. FIGS. 3A and 3B, 4 and 5 illustrate application of the various broadly designated functions shown in FIG. 2. Therefore, initial broad reference will be made to FIG. 2 with subsequent application of various functions described in relation to FIGS. 3A, 3B, 4 and 5 using consistent numbering as applicable.

Returning to FIG. 2, platform 101 employs local database 202 operated by a local operating system as discussed above. At 201 provisioning data 203, such as class of service, service plans, dialing plans, tariff tax tables and business rules for each customer from back office master data base 216 is provided to local database 202. Platform 101 employs look-up tables in database 202 to answer multiple series of questions. As an example, when at 210 a subscriber picks up and dials a number, the dialed number from that call comes into platform 101. That dialed number is translated into a category and compared to a look up table at 211 to determine if the dialed number is a 911, toll free or long distance call or if that number is a local call from the calling number. Then, also at 211, another database may be referenced to determine if the call can go forward for that customer. If the customer uses a call feature such as *69, *82, conference calling or the like, another database may be used for a lookup to determine if the calling number may use such a service. Preferably, yes or no answers are provided at 211. At 212 if the call cannot be completed due to a lack of authorization for a category of service, such as a customer who has elected to have no long distance, a message to the effect “I'm sorry, you do not have that kind of service available” is played for the customer. By authorizing a call prior to the Class 5 switch, the platform makes more efficient use of the Class 5 switch and SS7 network by not tying up switch ports and trunk lines for calls that cannot be completed due to authorization failures. If the answers at 211 are yes, then the call is verified against other look-up tables. The call preferably progresses until a determination is made whether the call can be completed. If, for example, the call is a long distance call, a look-up table is employed to check applicable rates and the taxes at 213 such as according to the called number's area code and exchange (NPA/NXX), to decide whether or not there is enough money in the calling customer's account for the call. If there are sufficient funds the call is completed. Platform 101 monitors the call to increment count and decrement the applicable prepaid customer balances at 214 based on how long that call lasts. Such decrements, or other increments may be made in one-tenth minute, six second, increments, or any other desired time increment. When the call is finished at 215 all balances in platform database 202 are updated so that when the next call is placed the platform may accurately determine if a call is properly funded.

Periodically, the updated information is sent to master database 216 to maintain a master record of all call processing, which may be accessible for customer service 206. Master database 216 includes customer billing information 205 as well as customer records 204, and service plan and business rules data 203. Local platform database 202 is also periodically updated using “snapshots” 217 of data from master database 216 and new customer information is uploaded from master database 216 to local database 202 as required. Customer billing information 205 is preferably maintained in real time on local database 202 for ongoing verification and prerating purposes.

For inbound calls at 220 and 222 where a subscriber of Platform 101 is the called party, the platform identifies the service type and provides service authorization or denies service at 221. At 221 the account of the called number is checked for status by category (i.e. suspended, disconnected, busy, call waiting, voice mail, can accept collect calls, etc.). If the call cannot be authorized, such as if the called subscriber's number is suspended or disconnected, a message is preferably played for the caller, so indicating at 223. For busy calls the platform may forward the call to voice mail or a forwarding number at 224. For prepaid customers the platform prerates collect calls based on applicable rates and monitors the call, decrementing the customers account balance at 225 and balances updated at 215. If at 221 incoming call 220 is determined to be a local or non-collect call, it is connected at 222.

In accordance with the present invention self-profiling feature 207 enables an enrolled subscriber to re-direct calls, set calling time limits or cost limits, block specific numbers (in or out), and the like. Preferably, these setting may be based on a day or days of the week, or time of day. Self-profiling may be web-based. In self-profiling the subscriber may have a PIN that enables access to a web site, which is preferably protected by firewalls. A customer may, for example, profile his account in the platform to automatically forward calls to a series of numbers at different times or on different days. Another example of self-profiling is that a parent can self-profile by identifying a number and specifying that during a period of time during the day the specified number will not be allowed to pass, or calls from that number may be forwarded to a different number during that period of time, such as where the parent will answer.

Turning to FIGS. 3A and 3B in outgoing call 300, the subscriber picks up their telephone and dials a number. The present platform uses the dialed number, to ascertain, in advance, the service type, whether the call is a local call or a long distance call, and what kind of initial routing needs to take place. At 301 the platform recognizes that that telephone has been picked up and recognizes the calling number. The platform uses the dialed number to identify the type of service and then determines whether the call is authorized at 302. The ANI of the number from which the call is dialed, the customer's number, is used to authorize the service. Generally, for a local call, the calling number ANI is immediately recognized, and if the call is a local call, 911 call or toll free call, the call is completed, a call record, in a standard format, is created at and the subscriber information database is updated to show a record of the call. However, if the call is denied at 302 a message is played to the customer that their call cannot be placed because the customer's service is suspended at box 306. In cases where service is denied the customer is preferably automatically forwarded to Customer Service at 306 as well. Customer Service may then discuss becoming current with the customer.

If the call is authorized at 302, then at 303 a determination is made as to whether the call is a “911” call or a toll free call such as an “800” call. If the call is a “911” or toll free call (303a), the call is automatically routed at 304a and a CDR is created at 304b, as is shown in box 304. Access to emergency “911” calls and toll free calls are typically a matter of legality. Federal and/or local statutes generally require that everyone who is provided phone service be allowed to make “911” calls or toll free calls. Therefore, for both credit-based customers and prepaid customers, no pre-rating occurs for “911” or toll free calls. The call is routed and a call data report is saved to the database. However, regulations do not typically require that “911” calls be connected if telephone service has been suspended or disconnected, even if there is dial tone on the line. Typically, operator interrupt capability is also legally required by Federal and/or state statute. In accordance with the present platform, operators are able to interrupt a call, typically employing a specific code.

If it is determined at 303 a call is a local call, call features are validated at 303c by checking the platform database. If the selected feature is unavailable to that customer a message that indicates they do not have that feature such as “I'm sorry you cannot use that feature today” is presented to the customer at 303d and the customer is preferably given an option of proceeding with the call without the selected feature. However, if the customer has the feature, the call is routed as is shown in 307. When the platform routes the call at 307a, the present platform starts a call detail record at 307b and when the call has been completed the platform, at 307c, updates the subscriber information in databases 216 and/or 202.

For an intrastate toll call, a long distance interstate call on M & M local call, or the like, the call is pre-rated based on the calling number ANI. For a prepaid customer this pre-rating takes into account where the call is directed, the resulting approximate cost, and local routing, as well as the status of the prepaid customer's account and whether the call is within the amount available in that prepaid customer's account. Returning to FIG. 3, if at box 302 the platform determines a call is a local toll call or a long distance call and if that customer is a prepaid customer, the platform checks local database 202, at 308a to see if that customer has a sufficient account balance to cover the call. An internal database call, termed a disconnect validation call, may be used by the platform to internally access the database to validate calls. At some point in time after an answer is gleaned from the database that connection to the database is disconnected, such as at 309d. Such calls and other exchanges of data within the present systems and methods are generally indicated in FIGS. 2, 3A, 3B and 4 by dashed lines. If the prepaid customer's account is active and contains a balance sufficient to pay the estimated cost of the call, the call is completed at 309.

Vertical and Horizontal Coordinates (V&H Coordinates) are typically used in long distance or toll billing systems. This is a standard in the telephone industry. Wherever a switch is located, it is identified by longitude and latitude, vertical and horizontal coordinates. The distance between two points is based on air miles measured between V&H coordinates in the Northern Hemisphere.

As part of pre-rating at 308a, rates and taxes are checked at 310 in order to determine how long the customer may stay on the call. An announcement may be used at 308a to tell a prepaid customer the number of minutes available for the call. If the customer does not have a sufficient balance to cover the call, the platform plays a message so indicating at 308a that may say, for example, “I am sorry you do not have enough money to make that call” or “I am sorry your call will be limited to 5 minutes based on the amount you have in your account.” Preferably, if the customer agrees with the limited time frame they may push a telephone button to proceed with the call. Features are validated for the toll or long distance call at 308b in a manner similar to that discussed above, with a message played at 308c if the feature is not available. Once the call is routed at 309a it is monitored at 312 and the customer's account is debited, in real time, including taxes and other charges. During the call, a call data record is created at 309b and the internal validation call may be disconnected at 309c. When the call ends, the subscriber information is updated, at 309d, in database 202 and/or updated in master database 216, decrementing the account balance for future phone calls in real time.

For credit-based customers call length availability announcements at 308a are typically disabled in the present platform. For prepaid customers these announcements typically remain in place unless provisions are made to remove them, such as prepayment of a minimum amount. Also, for prepaid calls remaining time notification may be disabled if, for example, a customer's service package allows the customer a given number of minutes of long distance calls. Preferably, pre-rating would be disabled up to the minute limit, and then pre-rating would automatically resume.

For charge-back calls, such as “900” calls, at box 315, credit based subscribers and prepaid customers may be treated differently, at 316 and 317, respectively. For pre-paid customers at 317, a personal identification number (PIN) may be required for completion of “900” calls at 317a. Because of the nature of “900” calls, which can be very expensive, the PIN requirement may be used to prevent fraud and unauthorized depletion of pre-paid customer accounts. At box 317a a PIN is requested and verified. After entry of a PIN, “900” calls are treated by the present platform similar to a long distance call. Once the requested PIN is validated at 317a, the “900” call is pre-rated at 317b, using information in local database 202. The subscriber is advised of time limits for the call at 317c. An internal validation call may be used by the platform to internally access the database to validate this call. The platform routes the call and the internal validation call is disconnected at 317d. A call detail record is created at 317e, and once the call is complete the subscriber information is updated at 317f.

Typically, for a credit based customer, “900” calls are treated by the present platform, at 316, similar to a regular long distance call. However, PIN verification for “900” calls may be offered to credit based customers, as an option in accordance with the present invention to prevent unauthorized use. Any such applicable PIN is requested and verified at 316a. The call is routed an any internal validation call used is disconnected at 316b. A CDR is created at 316c and subscriber information on database 202 and/or 216 is updated at 316d once the call is completed.

Operator or directory assistance requests 320 are handled by the present platform in a manner similar to a long distance call. For operator or directory assistance calls 320, the call is validated at 320a based on the digits that are dialed, for example “411”. A directory assistance call is pre-rated or validated at 320a based on whether or not that customer has sufficient money in their account to allow them to make a directory assistance call. An internal database validation call may be used by the platform to query the database to determine if this customer is entitled to this service, deriving a yes or no answer. For example, in a standard service package a customer may be given the ability to place two directory assistance calls without charge. In this example when a third directory assistance call is placed the platform will preferably notify the customer with a message, such as, “I am sorry but you have used up your allocation of directory assistance for the month”. The customer may be given an opportunity to debit a different account in order to pay for a directory assisted call. Once the call is validated at 320a, it is routed and the validation call is disconnected at 320b, a call detail record is created at 320c, and the subscriber database is updated at 320d.

Preferably, the present systems and methods enable rearranging funds from one sub-account within the customer's account to another sub-account. For example, if a customer has a prepaid long distance balance of ten dollars, but the customer wishes to place a Directory Assistance call, which has a cost of one dollar, but the customer has not prepaid for Directory Assistance. The present platform enables the customer to debit money from the long distance subaccount in order to pay for the Directory Assistance call.

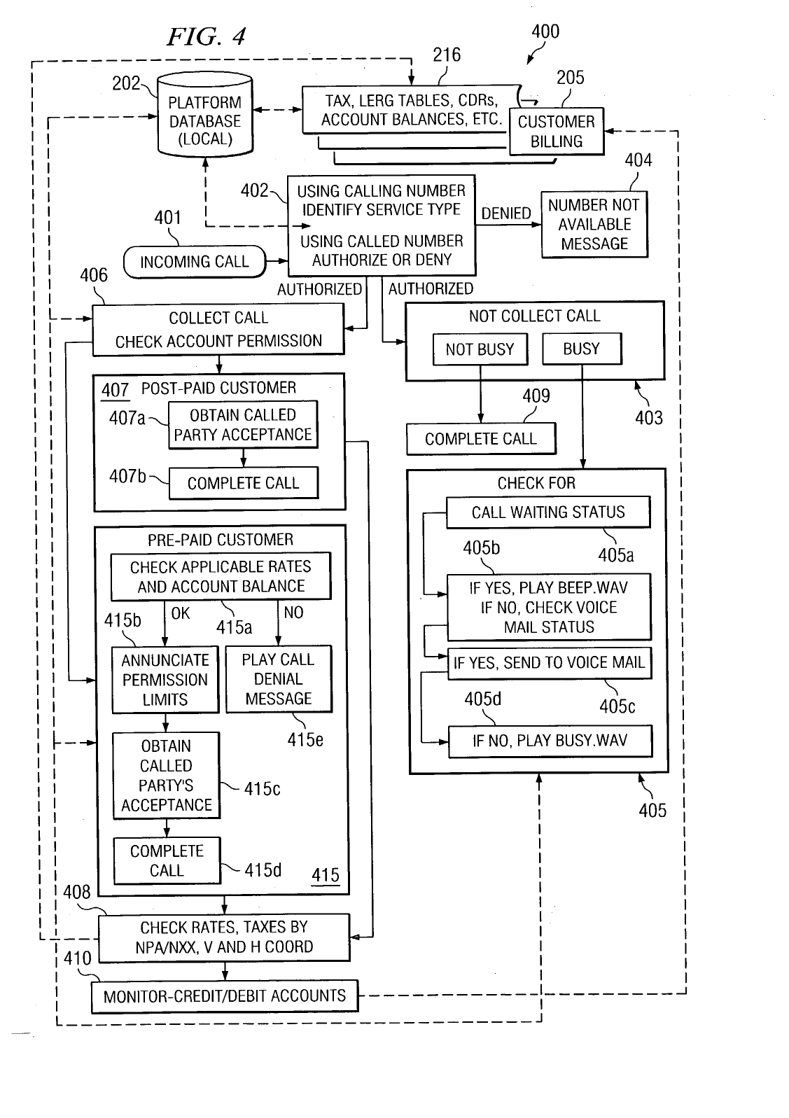

Turning to FIG. 4, for inbound calls 400, the platform first determines where a call is coming from, and to which subscriber the call is being placed. For incoming call 401 the platform uses the calling number to identify the type of service at 402. Preferably, anytime a subscriber is called, the service type identification is reviewed. If the call is a regular incoming call, not a collect call (403) and if the number called is a current customer number that can be authorized at 402, the call is connected at box 403 and 409. However, service is preferably denied at 402 for an incoming call if service has been suspended or been temporarily disconnected for the receiving customer. For example, if the customer is suspended or disconnected then a voice unit provides a message at 404, such as “I am sorry this number is no longer in service or temporarily out of service”. If the called number is busy a check is made at 405 to see what kind of features the called customer has —such as call waiting, call forwarding or voice mail. If the called customer has call waiting as determined by checking local database 202 at 405a, a beep can be played at 405b to tell the person who is being called that there is a call waiting for them. If it is determined from an inquiry of database 202 that the called customer does not have call waiting but does have voice mail at 405b, the call is forwarded to voice mail at 405c. Otherwise, a busy signal is played at 405d.

If the incoming call is a collect call the platform treats the call much like an outgoing long distance call, beginning a box 406 where an initial determination is made as to whether the called number has elected to block all collect calls. If receipt of a collect call is not approved for the called number, a message may be played for the calling party, for example, “I am sorry but this phone number cannot receive collect calls”. If the receiving party is a credit based customer who has elected to have collect calls passed to him, the call goes forward in a conventional manner at 407, such as by obtaining the called party's acceptance at 407a of the charges and connecting the call at 407b. Rates and taxes are checked at 408 to create a record for billing the customer at a later time and the call is monitored at 410 to determine call length for billing.

If the call is a collect call to a prepaid customer that has elected to receive collect calls, it is treated at 415 similar to a prepaid long distance call, and a determination is made as to whether the receiving customer has money in their account, typically their long distance account, to pay for a collect call at 415a. A voice prompt may be used at 415b to tell the customer if they accept the call how much time will be available. For example, if the call is authorized the customer is informed they have a collect call and how long their call is going to be able to last, based on their account balance. If the call is accepted by the prepaid customer at 415c, the call is completed at 415d. The call is monitored at 410 and the customer's account is debited in real time at 410, once the call is complete. If the call is not authorized at 415a a message may be played at 415a indicating to the calling party that the call cannot be completed.

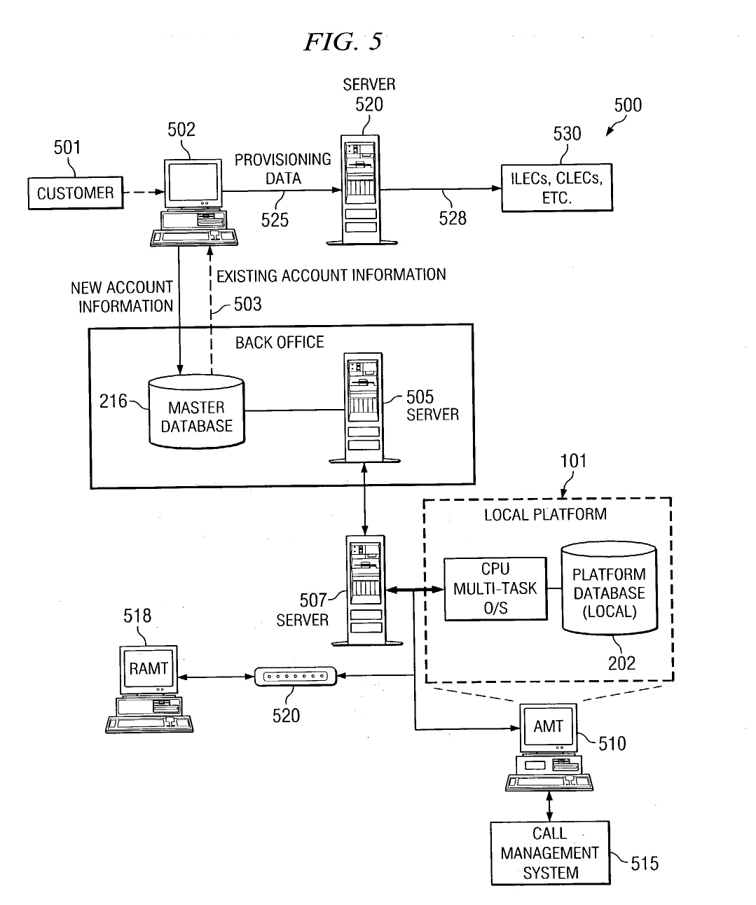

FIG. 5 is a graphic illustration of service provisioning 500. Any time that a party is connected to a telephone system some form of data about that customer should be collected. The customer is assigned a telephone number and a Class 5 switch is typically programmed to recognize a wire pair, or local loop, to which that customer is connected. So when that customer picks up the phone the Class 5 switch recognizes the customer by the wire pair connection, or if a customer is being called, the Class 5 switch recognizes what wire pair to connect to for completion of the call. Providing this information is typically referred to as the provisioning process.

However, for provisioning in accordance with the present systems and methods, provisioning data must be provided to the local platform database as well. For example, customer 501 calls a provider and customer service 502 for the provider records customer information. That information is provided to master database 216. The information in master database 216 is also available back to customer service 502, via link 503 if needed to answer future questions for a customer. Provisioning data may include the customer's assigned telephone number, name and address (for “911” purposes). This provisioning data may also include features to which the customer has subscribed such as Caller ID, Call ID with Name, Call Waiting, Call Conferencing, Three-Way Calling, Call Forwarding and/or the like. All of this information is made a part of the provisioning process whether or not such features may be employed for the customer. In an ILEC the master database may be referred to as a line information database (LIDB).

In embodiments of the present systems and methods, segments of the provisioning information in master database 216 are disseminated through servers 505 and/or 507 to local platforms 101. For example, a partition of master database 216 may be set aside for customers in the state of Texas and so all of the provisioning information for customers in the state of Texas goes into that partition, and only that one partition will be uploaded or downloaded through the servers into the local databases 202 of platforms 101 in Texas. In contrast, a platform in the state of Illinois receives a different segment of the master database with only Illinois customer information. Master database server 505 and local platform server 507 can communicate using IP addresses and are preferably secured by firewalls. Server 505 for master database 216, has a directory of Internet Protocol (IP) addresses for directing information segments to local platforms 101. A server such as server 507 is typically employed for each local platform 101.

Local administration maintenance terminal (AMT) 510, preferably provides access to particular platform and platform related information such as the call detail records for that platform this terminal may automatically receive alarm information, call record information and the like. Preferably, this AMT is also part of the call management system 515. Call management system 515 preferably includes an operating system, call authorization processes, enhanced number translations, time of day routing, a graphical interface, provisioning data, monitoring for alarm messages, paging service for major alarms, call detail records, and/or the like. These items making up call management system 515 are preferably fed out of the local platform and/or updated periodically by master database 216. Remote administration may be provided via remote administration maintenance terminal (RAMT) terminal 518 and modem (or server) 520 to access the platform and platform related information such as the call detail records for that platform and to also automatically receive alarm information, call record information and the like.

Provisioning data is also provided via link 525, to server for 526 and link 528 to ILEC or CLEC 530. In the provisioning process, if a platform is co-located with a third party CLEC or ILEC and the platform is feeding a Class 5 switch, that switch is typically dedicated to the platform That switch needs to know where to send information or where to accept information from. So in the provisioning process through standards, such as those promulgated by Electronic Data Systems (EDS), the present systems and methods automatically inform third party CLEC or ILEC 530 how to set up their switch to accept calls via the present platform. Also, during the provisioning process “911” groups need to be informed of the names and the addresses of the people associated with the assigned ANI. The provisioning process may only share a portion of customer related information with third parties such as ILECs, CLECs or “911” groups, as necessary.

Servers 505, 507 and 520, are preferably separate servers to facilitate communication of provisioning data at distances. Because of the nature of provisioning data and the volume of the data, a server is used so that the provisioning data can be separately handled at each location as required.

The present platform provides a convenient avenue for one party (customer) to provide telephony services for another party while maintaining control over those services and the costs involved therewith. For example, the present platform, particularly in conjunction with the self profiling feature, would be useful to a parent desiring to provide a child away at school basic telephone service and a budgeted amount for toll calls. Further, by pre-setting dollar amount limits, or designating a number that cannot be called, the account can be validated and calls authorized or limited as if it were a prepaid account even if the account is a credit-based account.

The present platform may be used for resale of communication services. The present platform provides the ability to allow others, even competing telephone companies, to use a provider's services. The re-seller can bring copper pair local loops to the present platform and access communication services via the platform thereby placing the platform between the customer and the switching network to enable control and tracking of services provided to a customer through the reseller.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A telephony service provision platform adapted to be disposed between a telephony subscriber and a telephony switch, said platform comprising:
at least one database of subscriber related information;
means for receiving communications from and to said subscriber;
means for determining eligibility of said subscriber for carrying out said communications to and from said subscriber; and
means for connecting said communications through said telephony switch.

2. The platform of claim 1 wherein said subscriber is a prepaid telephony customer and said database comprises an account status of said customer.

3. The platform of claim 1 wherein said subscriber is a prepaid telephony customer and said database comprises an account balance of said prepaid customer.

4. The platform of claim 1 wherein said means for determining eligibility validates said subscriber as an active customer based on automatic number identification.

5. The platform of claim 1 wherein said means for determining eligibility determines if said subscriber has sufficient funds in a prepaid account to pay tolls related to said communications.

6. The platform of claim 1 wherein said telephony switch comprises a Class 5 switch.

7. The platform of claim 1 wherein said database is local to said platform, said local database in communication with a master database, said local database comprising at least a portion of subscriber data maintained on said master database.

8. A communications system comprising:
a master database; and
a local platform disposed between subscriber premises equipment and a telephony switch said platform comprising:
a local database comprising a snapshot of data of said master database of at least subscribers connected to said local platform;
means for determining eligibility of said subscribers for communication service;
means for intercepting and controlling communications from and to said subscribers; and
means for connecting said communications through said switch.

9. The system of claim 8 wherein at least one of said subscribers is a prepaid telephony customer and said databases comprises account statuses of prepaid customers.

10. The system of claim 8 wherein at least one of said subscribers is a prepaid telephony customer and said databases comprises account balances of said prepaid customers.

11. The system of claim 8 wherein said means for determining eligibility validates a subject one of said subscribers is an active subscriber based on automatic number identification.

12. The system of claim 8 wherein said means for determining eligibility determines if a subject one of said subscribers has sufficient funds in a prepaid account to pay tolls related to said communications.

13. The system of claim 8 wherein said telephony switch comprises a Class 5 switch.

14. A method for providing telephone service eligibility verification comprising the steps of:
providing a platform disposed between a subscriber and a telephony switch;
receiving by said platform indications of calls placed to and by a subscriber;
identifying, by said platform, a service type of each of said calls;
determining by said platform if said subscriber is eligible to receive and place said calls, using any service features related to said calls; and
routing by said platform eligible calls to and from said subscriber through said switch and a telephony signal system.

15. The method of claim 14 wherein said service type comprises at least one service type selected for a group of service types consisting of:
an outgoing local call;
an outgoing toll free call;
an outgoing emergency services call;
an outgoing toll call;
an outgoing local toll call;
an outgoing long distance toll call;
an outgoing directory assistance call;
an outgoing operator assistance call;
an outgoing chargeback call;
an incoming collect call;
an incoming toll free call; and
a voice mail related call.

16. The method of claim 14 wherein said determining further comprises validating said subscriber is an active customer based on automatic number identification.

17. The method of claim 14 wherein said determining comprises looking up in a platform database an account status of said customer.

18. The method claim 14 wherein said subscriber is a prepaid telephony customer and said determining comprises looking up in a platform database an account balance of said prepaid customer.

19. The method of claim 14 wherein said determining further comprises establishing whether said subscriber has sufficient funds in a prepaid account to pay tolls related to one of said calls.

20. The method of claim 14 wherein said determining further comprises establishing whether said subscriber has sufficient funds in a prepaid account to pay tolls related to said service features.

21. The method of claim 14 further comprising:
creating a call detail record for each of said calls.

22. The method of claim 14 further comprising:
updating subscriber information upon completion of each of said calls.

23. The method of claim 14 further comprising:
informing, in response to said determining, said subscriber that said subscriber is not eligible to place a call.

24. The method of claim 14 further comprising:
informing, in response to said determining step, a party placing an incoming call that said subscriber's number is not in service.

25. The method of claim 14 further comprising:
informing, in response to said determining step, a party placing an incoming collect call that said subscriber does not accept collect calls.

26. The method of claim 14 further comprising:
the step of informing said subscriber of a projected maximum duration of a call based on a prepaid account balance of said subscriber.

27. The method of claim 14 further comprising:
forwarding said subscriber to a customer service provider in response to a negative determination at said determining step.

28. The method of claim 14 wherein said determining comprises establishing by said platform said subscriber has active voice mail, and said routing comprises routing an incoming call to a busy subscriber number to voice mail.

29. The method of claim 14 wherein said determining comprises establishing by said platform said subscriber has active call forwarding, and said routing comprises routing an incoming call to said subscriber to a number indicated by said active call forwarding.

30. The method of claim 14 wherein said telephony switch comprises a Class 5 switch.

31. A method for providing telephone service eligibility verification for outgoing calls, said method comprising the steps of:
providing a platform disposed between a subscriber's premises telephony equipment and a telephony switch;
receiving by said platform an indication of a call placed by said subscriber;
identifying, by said platform, a service type of said call using a called number of said call;
determining by said platform if said subscriber is eligible to place said call, using any related service features; and
routing by said platform an eligible call to said switch and through a telephony signal system.

32. The method of claim 31 wherein said service type comprises at least one service type selected for a group of service types consisting of:
a local call;
a toll free call;
an emergency services call;
a toll call;
a local toll call;
a long distance toll call;
a directory assistance call;
an operator assistance call;
a chargeback call; and
a conference call.

33. The method of claim 31 wherein said determining further comprises validating said subscriber is an active customer based on automatic number identification.

34. The method of claim 31 wherein said determining comprises looking up in a platform database an account status of said customer.

35. The method claim 31 wherein said subscriber is a prepaid telephony customer, and said determining comprises looking up in a platform database an account balance of said customer.

36. The method of claim 31 wherein said determining further comprises establishing whether said subscriber has sufficient funds in a prepaid account to pay tolls related to said call.

37. The method of claim 31 wherein said determining further comprises establishing whether said subscriber has sufficient funds in a prepaid account to pay tolls related to said service features.

38. The method of claim 31 further comprising:
creating a call detail record for said call.

39. The method of claim 31 further comprising:
updating subscriber information upon completion of said call.

40. The method of claim 31 further comprising:
informing, in response to said determining, said subscriber that said subscriber is not eligible to place said call.

41. The method of claim 31 further comprising:
forwarding said subscriber to a customer service provider in response to a negative determination at said determining step.

42. The method of claim 31 wherein said call is a toll call, said method further comprising:
informing said subscriber of a projected maximum duration of said call based on a prepaid account balance of said subscriber.

43. The method of claim 31 wherein said telephony switch comprises a Class 5 switch.

44. A method for providing telephone service eligibility verification for incoming calls, said method comprising the steps of:
providing a platform disposed between a subscriber's premises telephony equipment and a telephony switch;
receiving by said platform an indication of a call placed to a subscriber;
identifying, by said platform, a service type of said call;
determining if said subscriber is eligible to receive said call, using any related service features; and
routing an eligible call through a telephony signal system.

45. The method of claim 44 further comprising:
routing a call to a busy subscriber number according to a call service feature.

46. The method of claim 44 wherein said determining comprises establishing by said platform said subscriber has active voice mail, and said routing comprises routing an incoming call to a busy subscriber number to voice mail of said subscriber.

47. The method of claim 44 wherein said determining comprises establishing by said platform said subscriber has active call forwarding, and said routing comprises routing an incoming call to said subscriber to a number indicated by said active call forwarding.

48. The method of claim 44 wherein said determining further comprises validating said subscriber is an active customer based on automatic number identification.

49. The method of claim 44 wherein said determining comprises looking up in a platform database an account status of said customer.

50. The method of claim 44 wherein said service type is a collect call.

51. The method of claim 50 wherein said determining further comprises establishing whether said subscriber has sufficient funds in a prepaid account to pay tolls related to said collect call.

52. The method of claim 44 further comprising:
creating a call detail record for said call.

53. The method of claim 44 further comprising:
updating subscriber information upon completion of said call.

54. The method of claim 44 further comprising:
informing, in response to said determining step, a party placing said incoming call, that said subscriber's number is not in service.

55. The method of claim 44 wherein said call is a collect call, said method further comprising:
informing said subscriber of a projected maximum duration of said call based on an account balance of said subscriber.

56. The method of claim 44 wherein said telephony switch comprises a Class 5 switch.
